(19) United States
(12) Patent Application Publication
(10) Pub. No.: US 2012/0017707 A1
(43) Pub. Date: Jan. 26, 2012

(54) SYSTEMS AND METHODS FOR DETECTING OBJECTS IN THE GROUND

(75) Inventors: Ronald Scott Jackson, Boise, ID (US); David W. Simmons, Middleton, ID (US); David A. Clark, Boise, ID (US)

(73) Assignee: WILLOWVIEW SYSTEMS, INC., Boise, ID (US)

(21) Appl. No.: 13/011,577

(22) Filed: Jan. 21, 2011

Related U.S. Application Data
(60) Provisional application No. 61/297,653, filed on Jan. 22, 2010.

(51) Int. Cl. G01D 21/00

(52) U.S. Cl. 73/866.5

(57) ABSTRACT

The presently disclosed systems and methods may be utilized in connection with several different sensor suites for detecting objects in the ground. Such systems and methods may be utilized in conjunction with a variety of military and commercial vehicles. In various embodiments, a sensing system may be carried by a vehicle in a stowed or deployed position. While in the stowed position, a segmented boom may have a relatively small vertical profile in comparison to the length of the boom when fully extended. According to various embodiments, in the deployed position the height of the sensor may be controlled to avoid obstructions. A hoist connected to the boom may be utilized to move the boom between the deployed and stowed positions.

### RELATED APPLICATIONS

This application claims the benefit under 35 U.S.C. §119(e) of U.S. Provisional Patent Application No. 61/297,653, filed on Jan. 22, 2010, titled “Systems and Methods for Detecting Objects in the Ground,” which is incorporated herein by reference in its entirety.

### TECHNICAL FIELD

The present disclosure relates generally to systems for detecting objects in the ground.

### BRIEF DESCRIPTION OF THE DRAWINGS

FIG. 1A illustrates a perspective view of one embodiment of a detection system supported by a configurable mounting system in a deployed position.

FIG. 1B illustrates a perspective view of one embodiment of a detection system supported by a configurable mounting system in a deployed position.

FIG. 1C illustrates a perspective view of one embodiment of a detection system supported by a configurable mounting system in a deployed position.

FIG. 1D illustrates a perspective view of one embodiment of a detection system supported by a generic mounting bracket designed to connect to a standard vehicle hitch receiver.

FIG. 2 illustrates a perspective view of one embodiment of a detection system in a deployed position with a three-part telescoping boom partially retracted.

FIG. 3A illustrates a perspective view of the detection system of FIG. 1A in a stowed position.

FIG. 3B illustrates a perspective view of the detection system of FIG. 1B in a stowed position.

FIG. 3C illustrates a perspective view of the detection system of FIG. 1C in a stowed position.

FIG. 3D illustrates a perspective view of the detection system of FIG. 1D in a stowed position.

FIG. 4A illustrates an exploded perspective view of one embodiment of a pivot point configured to connect a detection system to a vehicle.

FIG. 4B illustrates a perspective view of one embodiment of a generic mounting bracket designed to connect to a standard vehicle hitch receiver.

FIG. 5A illustrates a perspective view of one embodiment of a detection system with one sensor head is partially deflected.

FIG. 5B illustrates a perspective view the detection system of FIG. 5A with both detector heads are partially deflected.

FIG. 6 illustrates a cross-sectional view of the detection system of FIG. 1A taken along line 6-6 and its mounting configuration to a support boom.

FIG. 7 illustrates a perspective view from below of the detection system illustrated in FIG. 1B, in which the sensor head is partially deflected.

FIG. 8 illustrates a cross-sectional view of the embodiment of a detection system head illustrated in FIG. 1B taken along line 8-8 and its mounting configuration to the support boom.

FIG. 9 illustrates a side view of the detection system of FIG. 7 and its mounting configuration to the support boom.

### DETAILED DESCRIPTION OF PREFERRED EMBODIMENTS

The presently disclosed systems and methods may be utilized in connection with several different sensor suites for detecting objects in the ground. Such systems and methods may be utilized in conjunction with a variety of military and commercial vehicles. In various embodiments, a sensing system may be carried by a vehicle in a stowed or deployed position. While in the stowed position, a segmented boom may have a relatively small vertical profile in comparison to the length of the boom when fully extended. According to various embodiments, in the deployed position the height of the sensor system may be controlled to avoid obstructions. A hoist connected to the boom may be utilized to move the boom between the deployed and stowed positions. The hoist may also be used to adjust the height of the sensor system with respect to the ground. In one embodiment, a single pivot bearing assembly may be utilized for raising and lowering the sensor system with respect to ground. In other embodiments, two bearing assemblies may be aligned in parallel. In other embodiments, two bearing assemblies may be aligned orthogonally to allow both lateral and vertical position adjustments of the deployed boom and sensor system.

The hoist may include a hoist vice and a winch. Further, in embodiments including a segmented boom, the distance in front of the vehicle of the sensor head may be adjusted to suit operating requirements and terrain as needed. For example, when operating on terrain that includes a large number of obstacles, the boom length may be shortened, and when operating on terrain that is relatively unobstructed, the boom may be maximally extended.

In various embodiments, systems according to the present disclosure may comprise a multi-part boom assembly. In one particular embodiment, the boom may comprise a three-part telescoping boom. The telescoping feature allows for a smaller vertical profile in the stowed position as well as allowing the horizontal distance between the vehicle and the sensor head to be adjusted in the extended position.

In embodiments including a three-part telescoping boom, a folding hinged socket piece may allow connection to a custom fore-boom designed to suit a sensor system. The folding hinged socket piece may be fabricated from a variety of materials, including but not limited to, stainless steel, carbon fiber, fiber reinforced plastic, etc.

In various embodiments, systems according to the present disclosure may comprise independent sensor system casings that can rotate independently about separate pivoting points.

A variety of types of sensor systems may be utilized in connection with the systems and methods disclosed herein. Such sensor systems may include, but are not limited to, a Geonics Flex 1 EM61 sensor system, a Geonics Flex 3 & 4 sensor system, the Safelane VEMOSS sensor system, a magnetometer system, a radar system, and an ultrasound system. Further, a variety of types of sensor systems may be used in combination and supported by a common boom.

In certain embodiments, a tensioning device may be utilized to maintain a sensor head in a first orientation that is approximately perpendicular to the boom. The tensioning device may exert a restoring force when the sensor head is not in the first orientation, causing the sensor head to return to the first orientation. The tensioning device may include two elastic cables attached to the sensor head and the boom. When the sensor head rotates, one of the cables is stretched. When the force that caused the rotation is removed, the stretched cable contracts, and causes the sensor head to rotate back to the first orientation. A single tensioning device attached to the sensor head may also be utilized to maintain the sensor head in the first orientation in various embodiments.

Mechanical stops may be utilized in other embodiments to maintain the sensor head in the first orientation. In certain embodiments, mechanical stops may be embodied as ball detents. In such embodiments, a threshold force may be required in order to cause rotation of the sensor head from the first orientation.

A common bracket based mounting system, which can be utilized with a variety of different vehicles, may couple the boom to a vehicle. In various embodiments, a common bracket based mounting system may contain the boom, mounting hinges, stow brackets, and the hoist and hoist controllers. The common bracket based mounting system may be configured to connect to a standard vehicle hitch receiver. Each of the boom, mounting hinges, and stow brackets may be self-contained, or in other words, may have only a single point of contact with the vehicle (e.g., using a standard vehicle hitch receiver). A custom designed mount may also be created that is specific to vehicles, for example for any of a Humvee, GMV, RG-33, Toyota Tundra, UK Panther CLV, etc. In various embodiments, a sensor system may be mounted directly to a vehicle or under a vehicle.

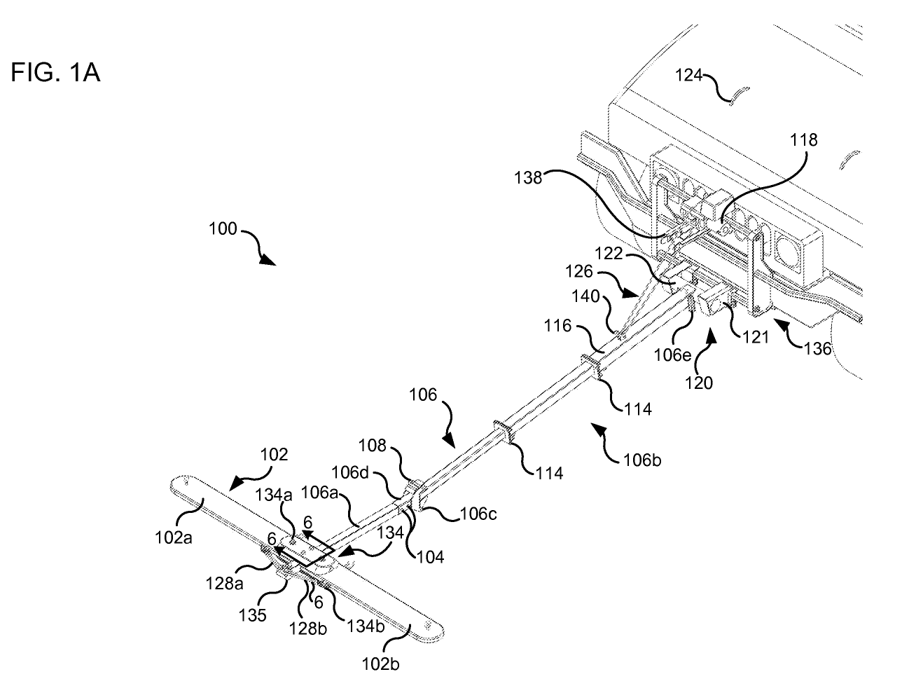

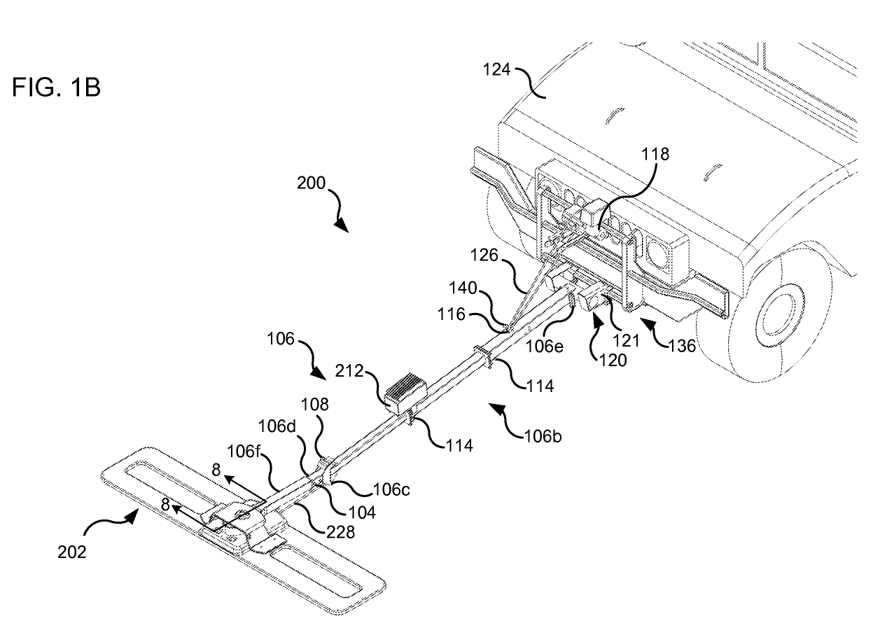

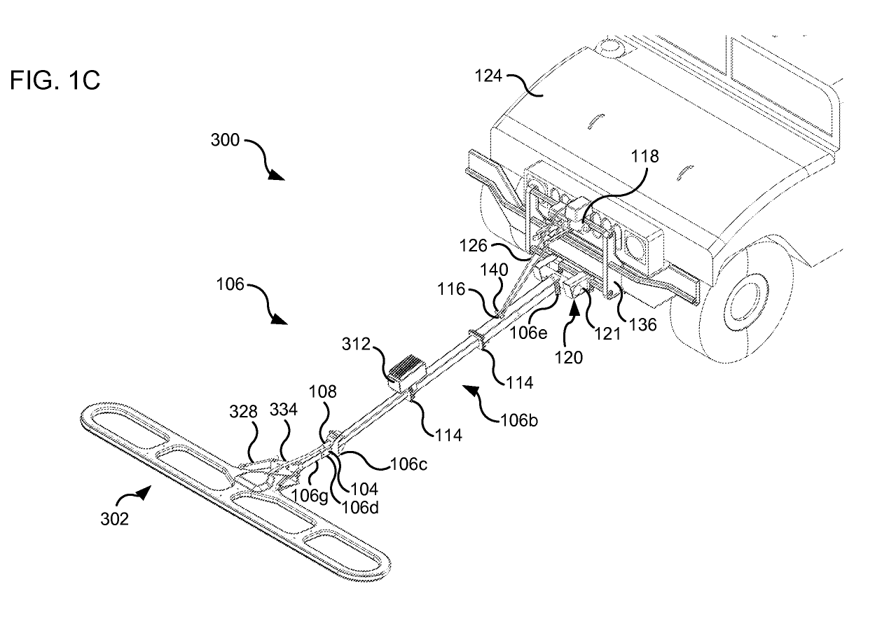

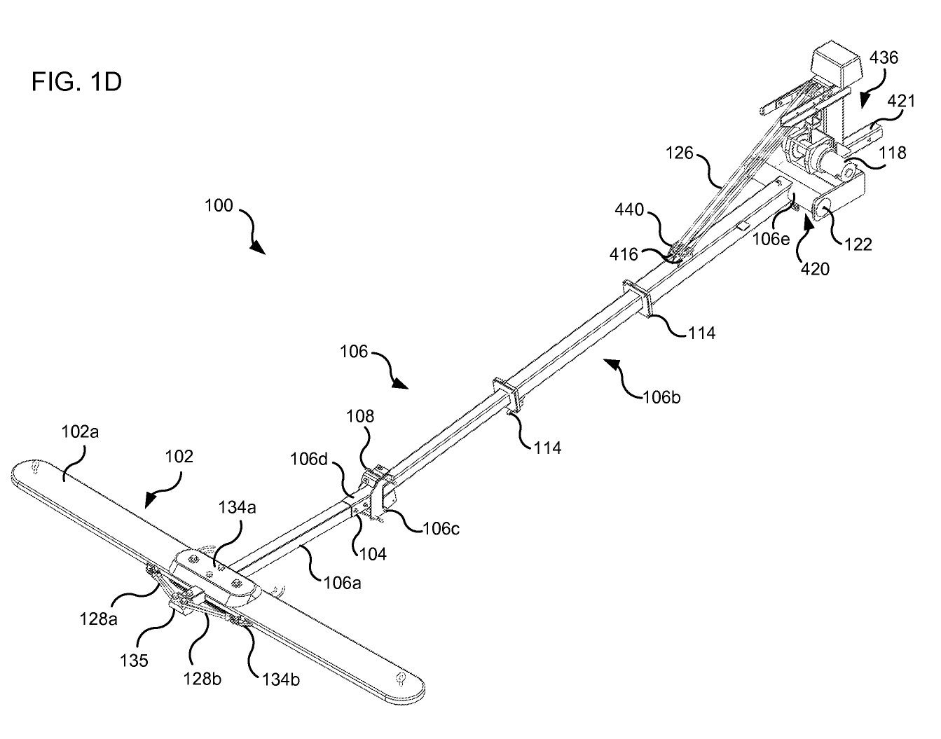

With reference to the accompanying drawings, FIG. 1A illustrates a sensor system 100 configured for detecting an object in the ground. Detection system 100 includes a two part sensor head 102a and 102b mounted to a boom 106. Boom 106 includes five primary sections, a distal boom section 106a mated to sensor head 102, a socket section 106d to hold the distal boom section 106a, a hinge joint 106c, a multi-part telescoping proximal boom section 106b, and a cylindrical pivot tube 106e oriented perpendicular to proximal boom section 106b. As shown in FIG. 1A, bolts or pins 104 can be used to secure distal boom 106a into socket section 106d. As shown in FIG. 1A, the multi-part telescoping proximal boom 106b can be extended to maximize the distance between a vehicle 124 and sensor head 102.

A vehicle mount 136 may be used to connect system 100 to a vehicle 124. Vehicle mount 136 may connect to a pivot joint 120, which may allow for boom 106 to pivot in a vertical plane. In some embodiments, a torsion spring (not shown) may be added to pivot joint 120 to reduce the moment arm on the lifting mechanism used to raise and lower boom 106 and the sensor head. In some embodiments, a rotational damper (not shown) may be added to pivot joint 120 to reduce bouncing of boom 106 in the deployed position. In certain embodiments, vehicle mount 136 is customized to a particular vehicle, while boom 106 and pivot joint 120 may be generic and are able to be mounted to a plurality of different types of vehicle mounts. According to alternative embodiments, a generic vehicle mount 136 may be utilized.

Vehicle mount 136 may comprise a hoist 118. Hoist 118 may be connected to a hoist line 126 running through a sheave 116, which is connected to proximal boom section 106b. Hoist 118 may be embodied, for example, as a commercially available 350 kg rate industrial hoist and may receive power from vehicle 124. Additional sheaves may be used in alternative embodiments to achieve greater mechanical advantage, to allow greater accuracy in adjusting the height of the sensor head, or to control transient motion (e.g., bending or vibration of boom 106). In other embodiments a hydraulic or pneumatic cylinder may be used for adjusting the height of boom 106 and sensor head 102 in place of hoist 118, hoist line 126, and sheave 116.

As hoist line 126 is drawn in by hoist 118, the height a sensor head 102 from the ground increases. Similarly, as hoist line 126 is let out by hoist 118 the height of sensor head 102 decreases. Increasing the height of sensor head 102 with respect to the ground may increase the ability to navigate rough terrain, while positioning the sensor head 102 near the ground may increase the sensitivity of a sensor disposed in sensor head 102 to an object in the ground by decreasing the distance between the sensor head 102 and the object. The optimal height of the sensor head above the ground may be influenced by a number of factors, including type of sensor, soil conditions, terrain, and the like. These considerations may be balanced by raising or lowering the sensor head 102 while a detection system is in operation.

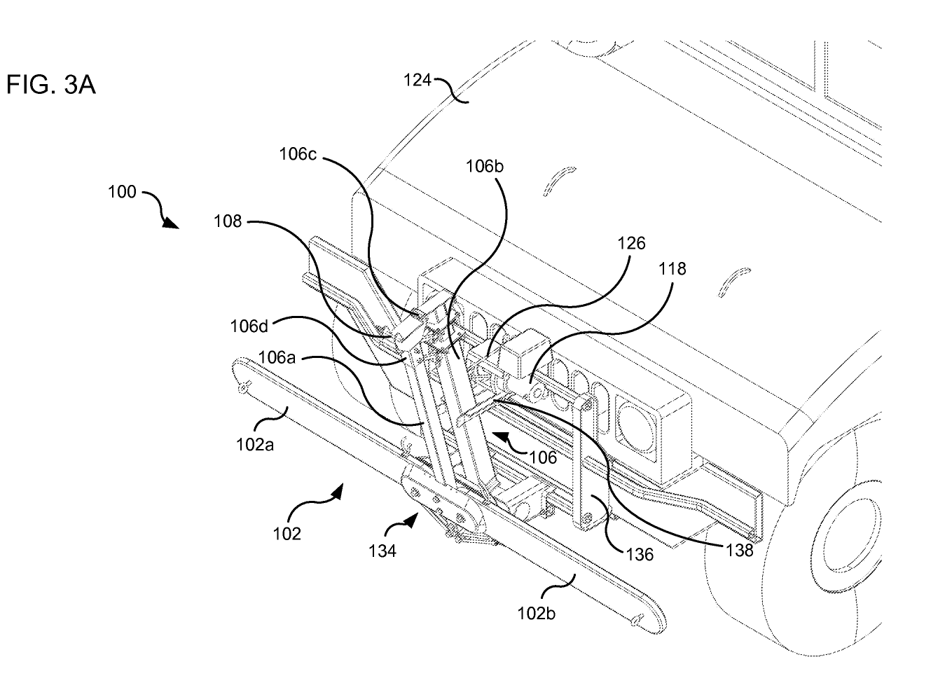

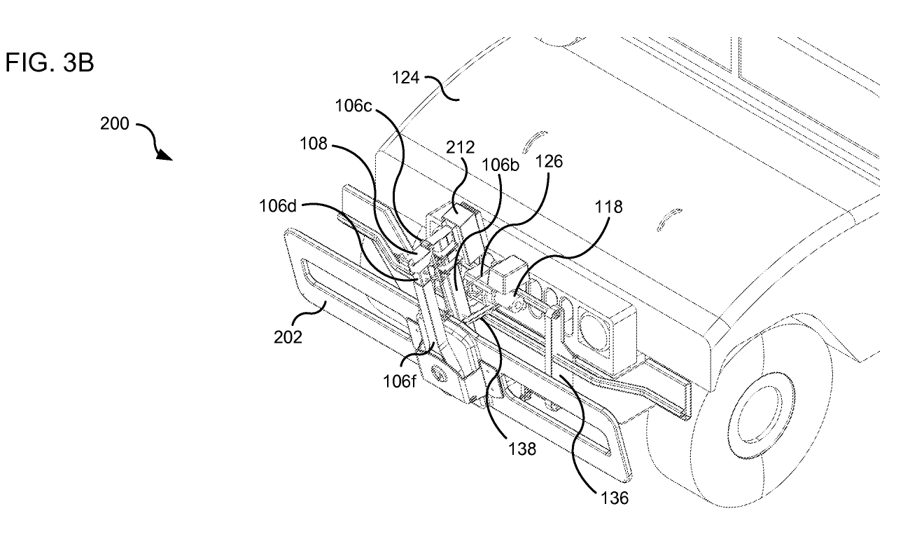

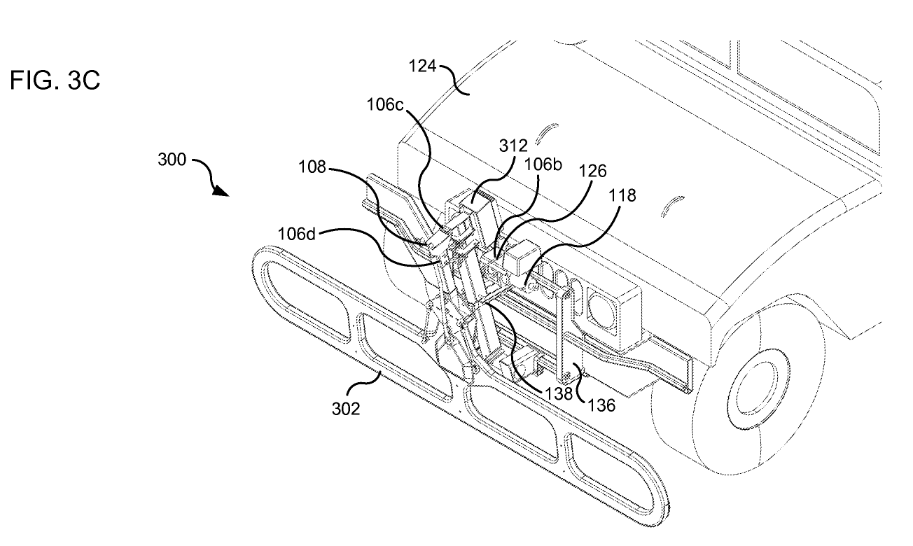

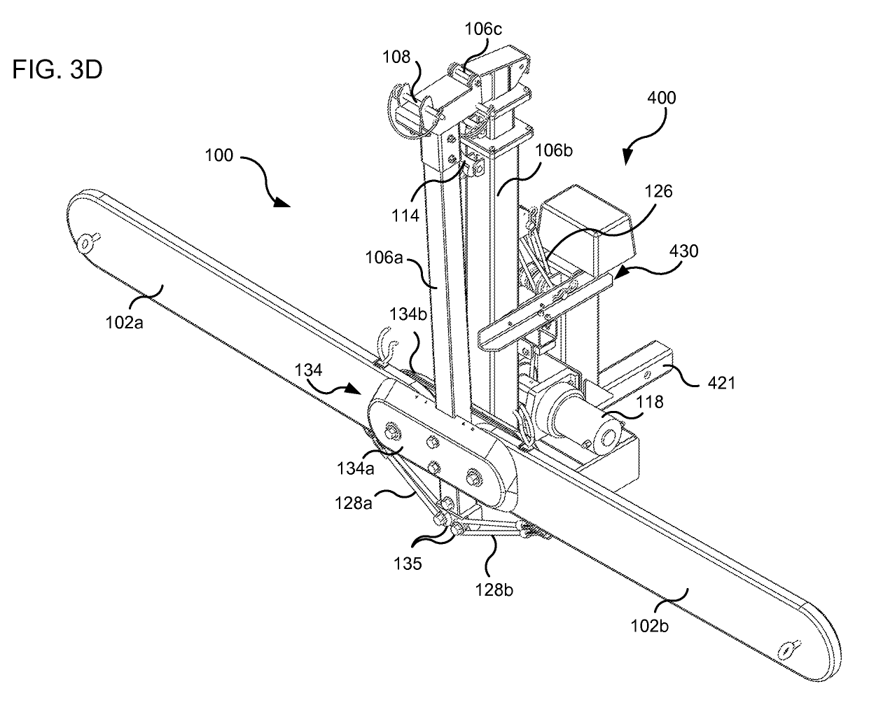

A pin 140 may be used to connect sheave 116 to proximal boom 106b. Pin 140 and a pivot shaft 122 may be removed to quickly detach boom 106 from vehicle 124. In certain embodiments, a safety strap (not shown) may be included to maintain boom 106 in an elevated position in case hoist 118 or hoist line 126 fail. Hoist 118 may be used to move proximal boom 106b into a stowed configuration, which will be described and illustrated in connection with FIGS. 3A-3D, by drawing in hoist line 126.

In certain embodiments a distance sensor (not shown) and a control system (not shown) may be utilized to automatically adjust the height of the sensor head 102 above the ground. The distance sensor may determine the distance between the sensor head 102 and the ground and provide the distance to the control system. The control system may control hoist 118 and may raise or lower sensor head 102 as appropriate, in order to maintain a desired distance between the sensor head and the ground. In other embodiments, an operator may raise and lower boom 106 from the cab of vehicle 124.

Multi-part telescoping proximal boom 106b can be partially retracted in order to adjust a distance between sensor head 102 and vehicle 124 in an extended position. The distance between sensor head 102 and vehicle 124 may be adjusted in order to accommodate a variety of conditions, such as variations in terrain and/or a desired amount of forewarning upon the detection of an object in the ground. Multi-part telescoping proximal boom 106b may be fully extended in order to maximize the distance at which an object in the ground may be located. According to certain embodiments, cam locks 114 may be utilized to adjust the distance between sensor head 102 and vehicle 124 in the extended position.

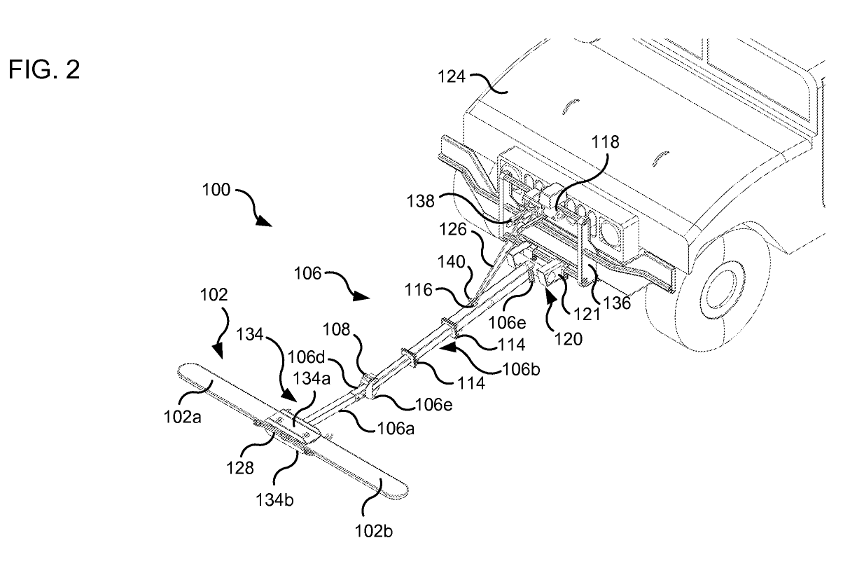

As shown as shown by comparing FIG. 1A and FIG. 2, multi-part telescoping proximal boom 106b can be partially retracted, and the distance between sensor head 102 and vehicle 124 may be adjusted. In some embodiments, hydraulic or pneumatic cylinders may be used to extend, retract, and adjust the length of multi-part telescoping proximal boom 106b.

As further illustrated in FIG. 3A, multi-part telescoping proximal boom 106b can be fully retracted to minimize the length of the boom and minimize the vertical profile of detection system 100 in a stowed position. A hinge joint 106c is disposed between distal boom section 106a and multi-part telescoping proximal boom section 106b. Hinge joint 106c may be embodied as an off-set hinge.

As is further illustrated in FIG. 3A, hinge joint 106c may bend, allowing distal boom section 106a and multi-part telescoping proximal boom section 106b to be held in a plane that is approximately perpendicular to the ground. As illustrated in comparing FIG. 1A and FIG. 3A, the distance between sensor head 102 and vehicle 124 in the extended position is greater than the distance between sensor head 102 and a vehicle 124 in the stowed position. A boom pin 108 may be used to secure distal boom section 106a and multi-part telescoping proximal boom section 106b in the extended position illustrated in FIG. 1A. In some embodiments, a remotely activated pin or a hydraulic or a pneumatic cylinder may be used so that boom 106 may be moved between the extended position (shown in FIG. 1A) and the stowed configuration (shown in FIG. 3A) without manual assembly by an operator of detection system 100. Boom 106 is attached to vehicle 124 using a vehicle mount 136. Boom 106 is connected to vehicle mount 136 at a pivot joint 120. In other embodiments, vehicle mount 136 may be designed to mount to a plurality of vehicles 124 using a generic connector.

FIG. 1B illustrates an embodiment of a detection system 200 configured for detecting an object in the ground. Detection system 200 includes a sensor head 202 mounted to a boom 106. Boom 106 includes five primary sections, a distal boom section 106f mated to sensor head 202, a socket section 106d to hold the distal boom 106a, a hinge joint 106c, a multi-part telescoping proximal boom section 106b, and a cylindrical pivot tube 106e oriented perpendicular to proximal boom section 106b. As shown in FIG. 1B, bolts or pins 104 can be used to secure distal boom 106f into socket section 106d. As illustrated in FIG. 3B, hinge joint 106c may bend, allowing distal boom section 106f and multi-part telescoping proximal boom section 106b to be held in a plane that is approximately perpendicular to the ground. As illustrated in comparing FIG. 1B and FIG. 3B, the distance between sensor head 202 and a vehicle 124 in the extended position is greater than the distance between sensor head 202 and a vehicle 124 in the stowed position.

FIG. 1C illustrates an embodiment of a detection system 300 configured to detect an object in the ground. Detection system 300 includes a sensor head 302 mounted to a boom 106. Boom 106 includes five primary sections, a distal boom section 106g mated to sensor head 302, a socket section 106d to hold the distal boom 106a, a hinge joint 106c, a multi-part telescoping proximal boom section 106b, and a cylindrical pivot tube 106e oriented perpendicular to proximal boom section 106b. As shown in FIG. 1C, bolts or pins 104 can be used to secure distal boom 106g into socket section 106d. As illustrated in FIG. 3C, hinge joint 106c may bend, allowing distal boom section 106g and multi-part telescoping proximal boom section 106b to be held in a plane that is approximately perpendicular to the ground. As illustrated in comparing FIG. 1C and FIG. 3C, the distance between sensor head 302 and a vehicle 124 in the extended position may be greater than the distance between sensor head 302 and a vehicle 124 in the stowed position.

FIG. 1D illustrates an embodiment of a detection system 100 that may be mounted on a vehicle using a generic mount 436. According to the illustrated embodiment, generic mount 436 may be configured to fit into a standard size vehicle hitch receiver via male connector 421 and to be secured by a hitch pin (not shown). Pivot joint 420 may be configured to stabilize boom 106 and to prevent sway and bounce of boom 106 and sensor head 102. According to other embodiments, other types of generic mounts may be used. For example, other mounts may include mounts that can be bolted directly to a vehicle frame.

FIGS. 3A, 3B, 3C, and 3D illustrate detection systems 100, 200, and 300, and 100 on the generic mount 436, respectively, in the stowed position. As discussed above, and as illustrated in FIGS. 3A, 3B, and 3C, hinge joint 106c may be embodied as an off-set hinge. Hoist 118 may move boom 106 between the extended and stowed position by retracting hoist line 126. A forked receiver 138 may receive proximal boom section 106b, in order to prevent sway of boom 106 while vehicle 124 is in motion. A connector (not shown) may be disposed on the sensor cable (not shown), which may be connected to electronics console 212 or 312, or an interface connection (not shown) that is mounted on vehicle mount 136, which may be connected in the extended configuration, and disconnected in the stowed configuration.

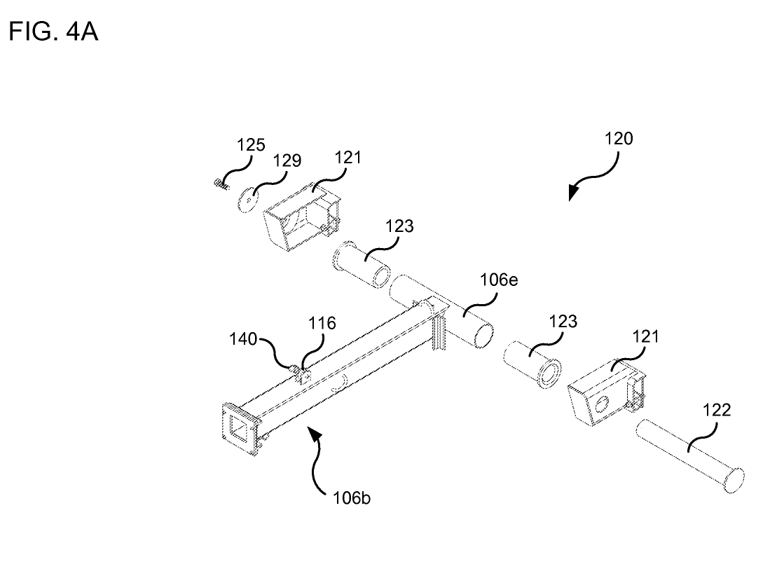

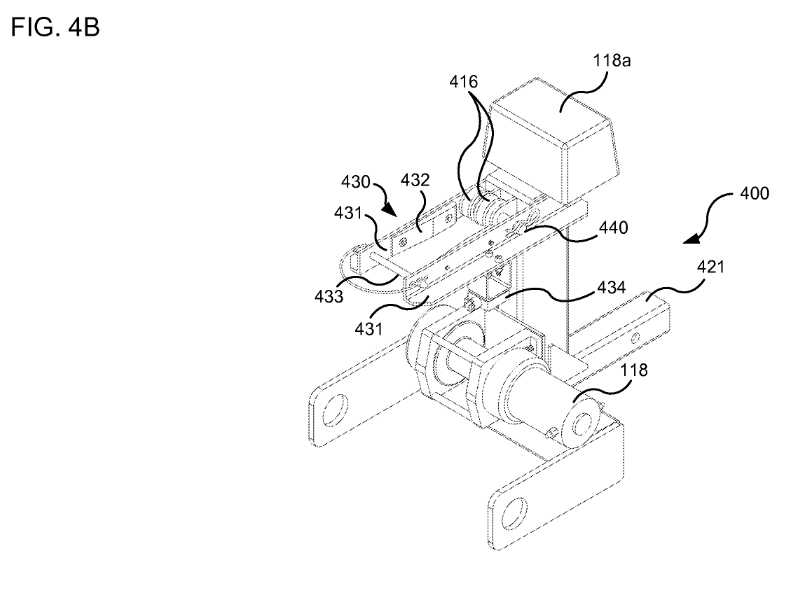

FIG. 4A illustrates an exploded view of one embodiment of a pivot joint 120. As illustrated in FIG. 4A, pivot joint 120 consists of two separate mounting pads 121, a pivot shaft 122 with a flange on one end and a threaded hole on the other, two bearing pads 123 running through the cylindrical end tube 106e, a capture flange 129, and a securing bolt 125. The pivot joint 120 may be configured to stabilize a boom (e.g., boom 106 illustrated in FIGS. 1A-1D) to prevent sway and bounce a sensor head (e.g., sensor heads 102, 202, or 302 illustrated in FIGS. 1A-1D). In some embodiments, a torsion spring (not shown) may be added to pivot joint 120 to reduce the moment arm on the lifting mechanism used to raise and lower boom 106 and the sensor head.

As illustrated in FIG. 4B, a generic mount 436 may be utilized in place of mounting pads 121 and hoist mounting bracket 138. Generic mount 436 may be configured to fit into any standard vehicle hitch receiver via male connection 421 and may be configured to be secured by a hitch pin (not shown). A boom (e.g., boom 106 illustrated in FIGS. 1A-1D) may be connected to generic mount 436 using a pivot shaft 122, bearing pads 123 running through the cylindrical end tube 106e, capture flange 129, and securing bolt 125, as illustrated in FIG. 4A. The hoist 118 and hoist contactor 118a may be mounted directly on generic mount 436.

Generic mount 436 may include a raised boom stowage bracket 430 consisting of two stow arms 431, two stow wedges 432, a stow pin 433 and a raised boom limit switch 434, which prevents hoist 118 from being stalled when the boom is fully raised into the stow bracket 430. Raised boom limit switch 434 may be configured to remove power from hoist 118 when the boom is fully raised. Accordingly, raised boom limit switch 434 may prevents electrical power from being applied to hoist 118 in the direction that causes the boom to be raised, but does allow power to the hoist in the direction that lowers the boom. Raised boom limit switch 434 may prevent damage to the hoist motor. Stow wedges 432 may be configured to receive the boom and guide the boom to the location between the first stow arm and the second stow arm. Generic mount 436 also provides two sheaves 416 and a sheave pin 440, through which hoist line 126 (shown in FIG. 1D) runs.

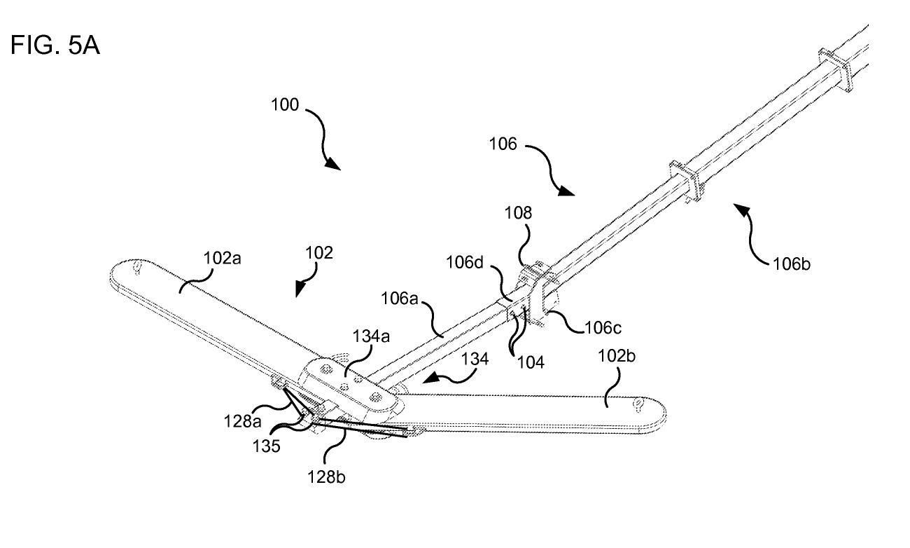

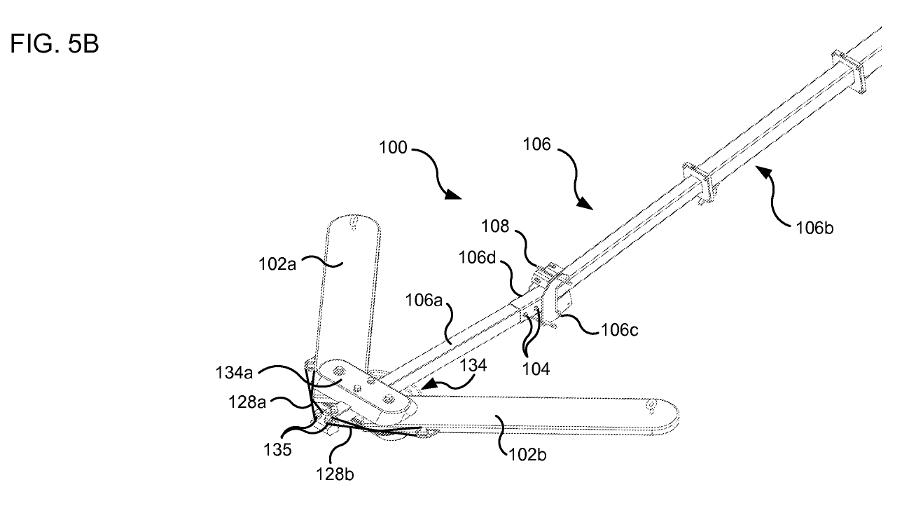

As illustrated in FIG. 5A, sensor head parts 102a and 102b are pivotally connected to the distal end of distal boom 106a. A head attachment assembly 134 is disposed near the distal end of distal boom section 106a. As shown in FIG. 5A, head attachment assembly 134 includes an upper head attachment assembly 134a and a lower head attachment assembly 134b. Sensor heads 102a and 102b are each received between the upper head attachment assembly 134a and the lower head attachment assembly 134b.

The shape of the sensor heads 102a and 102b on the side adjacent to distal boom 106a may be configured to allow the sensor heads 102a and 102b to rotate back towards distal boom 106a by up to 90 degrees while preventing rotation forward of distal boom 106a past the point where the sensor head is perpendicular to distal boom 106a. When either sensor head 102a or 102b, or both, contacts a fixed object, and a threshold force is exerted, one sensor head may pivot into an orientation as illustrated in FIG. 5A, or both may pivot to an orientation as illustrated in FIG. 5B. By pivoting, the sensor head(s) may avoid damage that may otherwise be caused by impact of the sensor head against a fixed object. Pivoting allows the sensor head(s) to avoid fixed objects that contact the sensor heads 102a and 102b beyond the outside edges of the head attachment assembly 134.

As illustrated in FIG. 5A, a tensioning cable 128a is disposed between the leading edge of sensor head 102a the tensioning cable cleat 135. Likewise, a tensioning cable 128b is disposed between the leading edge of sensor head 102b the tensioning cable cleat 135. When either sensor head 102a or 102b, or both, contacts a fixed object, and a threshold force is exerted to pivot the head(s) the tensioning cables 128a and/or 128b exert a restoring force so that when the force that caused the sensor head to pivot is removed, the tensioning cable 128a and/or 128b returns the sensor head(s) to a position that is perpendicular or approximately perpendicular to distal boom 106a. In one embodiment, tensioning cables 128a and 128b are embodied as polyurethane bungee cords having a diameter of 5/16″, commercially available as part no. 3961T3, form McMaster-Carr Supply Co., Santa Fe Springs, Calif.

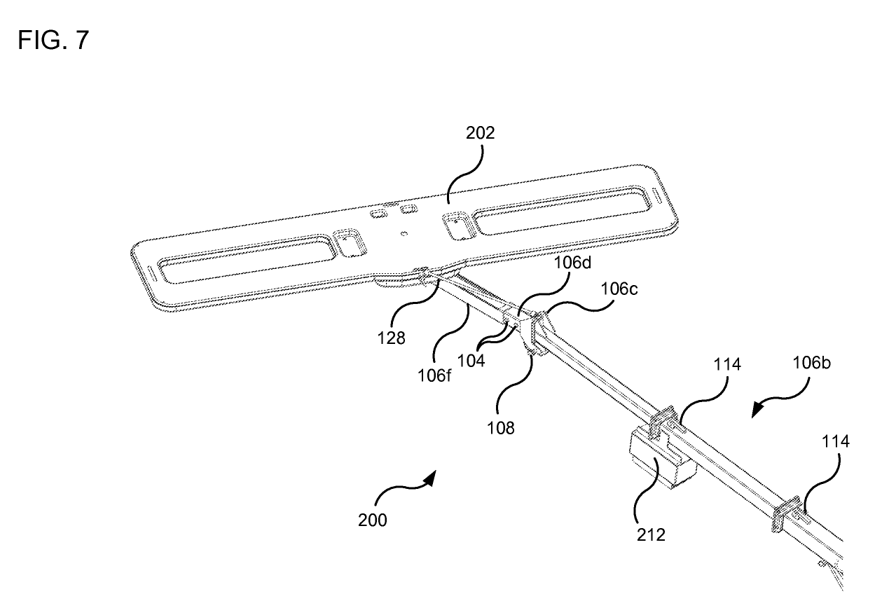

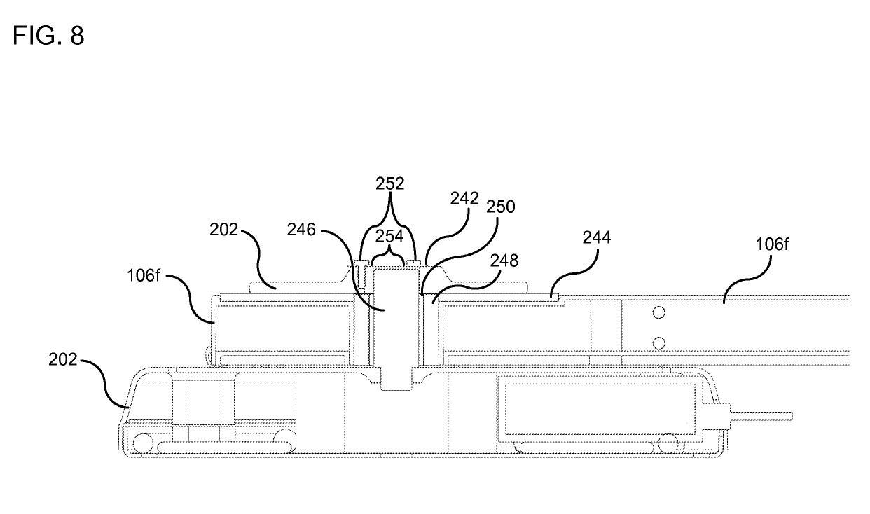

As illustrated in FIG. 1B, a detection system 200 can be mounted to the multi-part telescoping proximate boom 106b. As illustrated in FIG. 7, which is a perspective view from below, sensor head 202 is pivotally connected to the distal end of distal boom 106f. As illustrated in FIG. 8, distal boom 106f is received in a slot formed into sensor head 202. Distal boom 106f is separated from the upper slot surface of sensor head 202 by a sliding disc 244. Sensor head 202 pivots around a pivot shaft 246, as shown in FIG. 8, in a plane that is substantially parallel to the plane of the distal boom 106f. Sensor head 202 is separated from pivot shaft 246 by concentric bearing 250 and an elastomeric cylinder 248. Pivot shaft 246 is retained in place by non-metallic bolts 252, and washers 254.

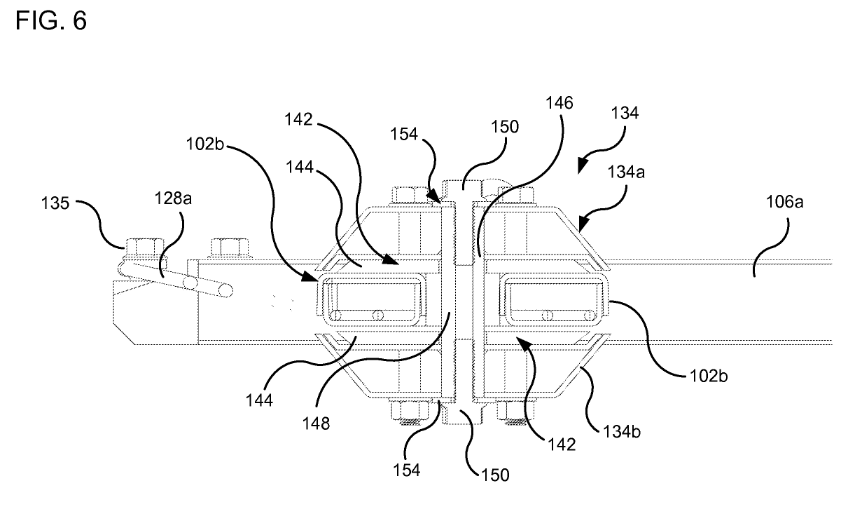

As illustrated in FIG. 6, sensor heads 102a and 102b are separated from the upper head attachment assembly 134a and the lower head attachment assembly 134b by a set of sliding discs 142. Sensor heads 102a and 102b each pivot around their own shaft 146 in a plane that is substantially parallel to the plane of the distal boom 106a. Sensor heads 102a and 102b are separated from their respective pivot shaft 146 by an elastomeric cylinder 148. Pivot shaft 146 is retained in place by a non-metallic bolts 150, and washers 154.

As illustrated in FIG. 7, when sensor head 202 contacts a fixed object, and a threshold force is exerted, the sensor head may pivot into an orientation as illustrated in FIG. 7. By pivoting, sensor head 202 may avoid damage that may otherwise be caused by impact of the sensor head 202 against a fixed object.

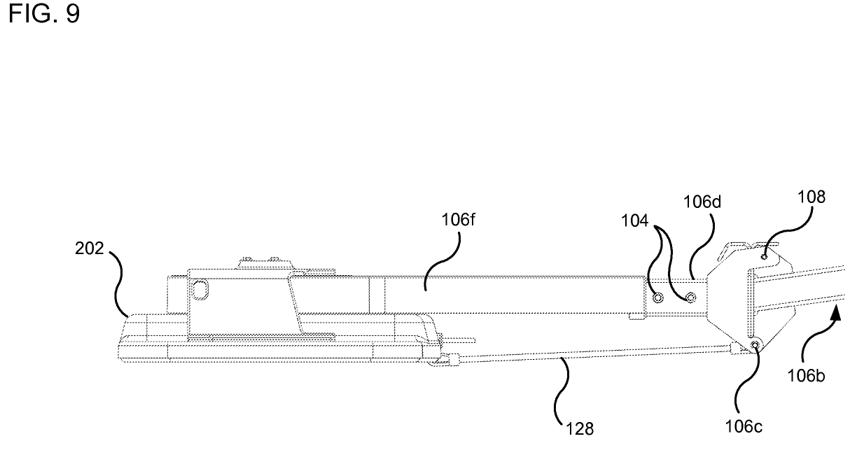

As illustrated in FIG. 7, a tensioning cable 128, which is more clearly shown in FIG. 9, is disposed between the trailing edges of sensor head 202 and the hinge 106c. When sensor head 202 contacts a fixed object, and a threshold force is exerted to pivot the head, the tensioning cable 128 exerts a restoring force so that when the force that caused the sensor head to pivot is removed the tensioning cable 128 returns the sensor head to a position that is perpendicular or approximately perpendicular to distal boom 106f. In one embodiment, tensioning cable 128 is embodied as a polyurethane bungee cord having a diameter of 5/16″, commercially available as part no. 3961T3, form McMaster-Carr Supply Co., Santa Fe Springs, Calif.

As illustrated in FIG. 1C, a detection system 300 can be mounted to the multi-part telescoping proximate boom 106b. In this embodiment the detection system 300 may comprise the EM61 Flex1 System, available from Geonics Limited, Mississauga, Ontario, Canada (the “the EM61 Flex1 System”). The characteristics of the distal boom 106g, sensor head 302 and associated pivoting mechanisms are fully described in commonly assigned co-pending U.S. patent application Ser. No. 12/428,356, titled “SYSTEMS FOR DETECTING OBJECTS IN THE GROUND,” which is incorporated herein by reference in its entirety.

Returning to FIG. 1A, in one embodiment sensor heads 102a and 102b contain a metal sensor for detecting metallic objects. The metal sensor may comprise the VEMOSS System, available from Safelane Consultants, Ltd., Aviemore PH22 1RH, United Kingdom (the “VEMOSS”). In another embodiment, as illustrated in FIG. 1B, the metal sensor may comprise the EM61 Flex4 System, available from Geonics Limited, Mississauga, Ontario, Canada (the “the EM61 Flex4 System”). In another embodiment, as illustrated in FIG. 1C, the metal sensor may comprise the EM61 Flex1 System. The VEMOSS System, the EM61 Flex4 System, and the EM61 Flex1 system all utilize pulse induction to detect ferrous and non-ferrous metal objects. In other embodiments, sensor head 102, 202, and 302 may contain a magnetometer, a radar system, an ultrasound system, or other types of systems for detecting objects in the ground. In various embodiments, a plurality of types of sensors may be utilized concurrently.

In order to avoid interference with a metal detector, in embodiments comprising a metal sensor, components of detection systems 100, 200 and 300 located near the sensor head(s) may be of non-metallic materials. Distal boom sections 106a, 106f, and 106g, heads 102, 202, and 302, and head attachment assemblies may be made of fiber reinforced plastic or glass reinforced plastic, in order to minimize interference with the metal sensor. Other components, such as pivot shafts 146 and 246 and bearing 250 may be fabricated from UHMW, Teflon®, or acetal. Other components of detection system 100, 200, and 300 that are separated from the metal sensor by a sufficient distance may be made of metal. In one embodiment, proximal boom section 106b is made of stainless steel to increase rigidity, minimize movement (e.g., sway and bounce), and minimize interference with the metal detector. The recommended separation from metal components varies according to the particular metal sensor used.

Sensor cable(s) (not shown) may be disposed along boom 106 to transmit information from the sensor to an operator of detection system 100, 200, or 300. For detection systems 200 and 300 an electronics console 212 (for detection system 200 as shown in FIG. 1B) or electronics console 312 (for detection system 300 as shown in FIG. 1C) may be disposed on proximal boom section 106b, and may be in communication with sensor cables from the sensor head.

Those skilled in the art will recognize that a plurality of detection systems can be configured to be mounted to a common boom system, and that the common boom system can be mounted to a plurality of vehicles with appropriate mounting adapters.

It will be obvious to those having skill in the art that many changes may be made to the details of the above-described embodiments without departing from the underlying principles of the present disclosure.

1. A detection system mountable to a vehicle for detecting an object in the ground, the detection system comprising:
a mount for coupling the detection system to a vehicle;
a boom coupled to the mount comprising:
a plurality of telescoping sections configured to allow for adjustment of a length of the boom;
a proximal end configured to couple to the mount; and
a distal end;
a sensor head pivotally connected to the distal end of the boom, the sensor head comprising:
a sensor configured to detect the object in the ground; and
a tensioning mechanism configured to hold the sensor head in a first orientation with respect to the boom, and to allow the sensor head to rotate from the first orientation with respect to the boom to a second orientation with the boom in response to the application of a threshold force, the tensioning mechanism being further configured to exert a force to return the sensor head to the first orientation when the sensor head is in the second orientation;
wherein the detection system is configurable in an extended configuration and a stowed configuration.

2. The detection system of claim 1, wherein the mount for coupling the detection system to the vehicle comprises a generic mount.

3. The detection system of claim 2, wherein the generic mount further comprises:
a male connection configured to fit into a standard vehicle hitch receiver;

4. The detection system of claim 2, wherein the generic mount is configured to allow the detection system to be mounted to any vehicle having a generic receiver.

5. The detection system of claim 1, further comprising a pivot point disposed between the mount and the sensor, the pivot point configured to allow for adjustment of the distance between the ground and the sensor.

6. The detection system of claim 1, wherein at least a terminal portion of the boom comprises non-metallic fiberglass.

7. The detection system of claim 1, further comprising a plurality of cam locks configured to temporarily secure each section of the plurality of telescoping sections with respect each other section of the plurality of telescoping sections.

8. The detection system of claim 1, further comprising:
a hinge joint disposed between the sensor head and the vehicle mount;
wherein in a first hinge position each section of the boom is approximately co-linear and in a second hinge position at least one section of the boom is approximately parallel with another section of the boom.

9. The detection system of claim 1, further comprising:
a hoist coupled to the boom, the hoist configured to at least partially adjust the configuration of the detection system between the extended configuration and the stowed configuration.

10. The detection system of claim 9, further comprising a raised boom limit switch configured to prevent the hoist from raising the boom beyond a specified point.

11. The detection system of claim 1, further comprising:
a hoist line coupled to the hoist; and
a hoist line sheave coupled to the boom and configured to receive the hoist line.

12. The detection system of claim 1, wherein the sensor has a primary axis, and wherein the primary axis of the sensor is substantially perpendicular to the boom in the first orientation.

13. The detection system of claim 1, wherein the sensor has a primary axis, and wherein the primary axis of the sensor is substantially perpendicular to the boom in the first orientation.

14. The detection system of claim 1, further comprising:
a distance sensor configured to determine a distance of the sensor from the ground;
a control system configured to receive the distance from the distance sensor and to control the hoist in order to maintain the sensor at a specified distance from the ground.

15. The detection system of claim 1, wherein the system is at least partially configurable from the extended configuration to the stowed configuration without manual assembly.

16. The detection system of claim 1, further comprising a stowage bracket configured to at least partially receive the boom in the stowed configuration.

17. The detection system of claim 16, wherein the stowage bracket comprises:
a first stow arm; and
a second stow arm, the boom being received in a location between the first stow arm and the second stow arm in the stowed configuration.

18. The detection system of claim 17, wherein the stowage bracket further comprises:
a first stow wedge coupled to the first stow arm; and
a second stow wedge coupled to the second stow arm, the first stow wedge and the second stow wedge configured to receive the boom and guide the boom to the location between the first stow arm and the second stow arm.

19. The detection system of claim 1, wherein the sensor head comprises:
a first sensor head section and a second sensor head section, each of the first sensor head section and the second sensor head section being configured to pivot independently from the other in a plane substantially parallel to the plane of the boom.

20. The system of claim 19, wherein the tensioning mechanism further comprises:
an attachment assembly connected to the boom;
a first elastic restraint connected to the attachment assembly and connected to the first sensor head section;
a second elastic restraint connected to the attachment assembly and connected to the second sensor head section; and
wherein the first elastic restraint and the second elastic restraint are disposed approximately symmetrical about the boom.

21. A detection system mountable to a vehicle for detecting an object in the ground, the detection system comprising:
a generic mount, the generic mount comprising:
a male connection configured to fit into a standard vehicle hitch receiver;
a boom coupled to the generic mount, the boom comprising:
a proximal end configured to couple to the generic mount;
a distal end;
a sensor head pivotally connected to the distal end of the boom, the sensor head comprising:
a sensor configured to detect the object in the ground;
a tensioning mechanism configured to hold the sensor head in a first orientation with respect to the boom, and to allow the sensor head to rotate from the first orientation with respect to the boom to a second orientation with the boom in response to the application of a threshold force, the tensioning mechanism configured to exert a force to restore the sensor head to the first orientation when the sensor head is in the second orientation; and
a multi-part boom assembly configured to be adjustable in length; and
a pivot point disposed between the mount and the sensor, the pivot point configured to allow for adjustment of the distance between the ground and the sensor.
